(19) United States
(12) Patent Application Publication
(10) Pub. No.: US 2014/0081711 A1
(43) Pub. Date: Mar. 20, 2014

(54) Systems and Methods for Improved Facility Energy Management and Retrofit Selection

(71) Applicant: CLEAN MARKETS, LLC, Philadelphia, PA (US)

(72) Inventors: Ellen Lutz, Philadelphia, PA (US); Christopher Bentley, Plymouth Meeting, PA (US)

(73) Assignee: CLEAN MARKETS, LLC, Philadelphia, PA (US)

(21) Appl. No.: 13/972,595

(22) Filed: Aug. 21, 2013

Related U.S. Application Data
(60) Provisional application No. 61/691,354, filed on Aug. 21, 2012.

(51) Int. Cl. G06Q 10/06

(52) U.S. Cl. CPC G06Q 10/0637
USPC 705/7.36

(57) ABSTRACT

Disclosed are systems and methods for energy management and facility retrofit option selection. The methods may be used to select between various retrofit options and may be used to provide return information to each participant in a retrofit project, including public and private participants.

### RELATED APPLICATIONS

This application claims priority to U.S. Provisional Application 61/691,354, “Systems and Methods for Improved Facility Energy Management and Retrofit Selection,” filed Aug. 21, 2012, the entirety of which application is incorporated herein by reference for any and all purposes.

### TECHNICAL FIELD

The present disclosure relates to the field of facility energy management.

### BACKGROUND

A challenge to increasing the market penetration of commercial energy efficiency retrofits is the lack of methods for connecting buyers of efficiency retrofits with investors in energy efficiency projects. Energy service providers find that the process for building owners and facility managers to decide to make an energy efficiency retrofit is lengthy, due to lack of availability of financial information about their return on investment, making it impossible to make the business case for the investment. Decisions to invest in a retrofit may be delayed at the management level, while the company creates its own financial model to determine the benefits and risks of the investment. This adds time to the decision process, and often stalls investment decisions indefinitely.

Facility administrators and owners have historically faced a lack of capital for efficiency investments. Investors feel that there is a dearth of investment-grade projects available. Project investors typically have to spend valuable time marketing to potential building owners, which marketing frequently requires an on-site visit by the investor. Several meetings may have to take place before the investor knows if the project will move forward or if will be a profitable investment. Accordingly, there is a long-felt need in the art for systems and methods capable of connecting buyers of efficiency retrofits with investors in energy efficiency projects.

### SUMMARY

In meeting the described challenges, the present disclosure provides methods of improving facility energy management. These methods suitably include one or more of (a) generating a predicted energy usage figure related to the use of one or more retrofit options selected from a set of retrofit options; (b) calculating a difference between the predicted energy usage figure and a comparative energy usage figure for the facility; (c) generating a cash flow figure and/or return on investment based at least in part on the difference; (d) generating the financial return from several retrofit financing options; and (e) generating a benefit/cost ratio for each retrofit project or combination of projects. The disclosed methods are suitably performed by using a computer processor to perform one or more steps of the methods.

The present disclosure also provides systems. The systems suitably include a computer processor; and a memory (e.g., a non-transitory computer-readable storage medium, or a transitory computer-readable storage medium) comprising instructions that, when executed, cause the processor to display on a device one or more fields for user selection of one or more facility retrofit options from a set of retrofit options, display on a device one or more fields for user selection of one or more facility configurations from a set of facility configurations, calculate a difference between a predicted energy usage figure related to user selection of one or more facility retrofit options and a comparative energy usage figure for the facility, and convert the difference to a cash flow, a financial return, or both. As described elsewhere herein, in some embodiments, the systems include a processor and a memory comprising instructions that, when executed, cause the processor to display on a device one or more fields for user selection, user input, or both, of one or more facility retrofit options from a set of retrofit options, display on a device one or more fields for user selection, user input, or both, of one or more facility configurations from a set of facility configurations, and calculate a predicted energy usage figure related to user selection. It should be understood that the disclosed systems may incorporate one or more functionalities (e.g., input by user, accessing data) that are performed over an internet connection. As one example, a user may use a personal computing device to select and input retrofit selections (e.g., a change to an existing HVAC system) via an internet connection to a processor that in turn executes particular operations based on that retrofit selection.

Further provided are methods of energy management for a facility, comprising receiving, over the internet, user selections (or, user input) of one or more retrofit options selected from a set of retrofit options; generating, using a computing device, a predicted energy usage figure related to the use of one or more retrofit options selected from a set of retrofit options (or one or more options that is input by a user); calculating a difference between the predicted energy usage figure and a comparable energy usage figure for the facility; generating financial indicators (which can be 1, 2, 3, 4, 5, 6, 7, 8, 9, or more indicators), generating one or more of a cash flow figure, a financial return for one or more (e.g., two or three) financing options, or other output based at least in part on the difference.

### BRIEF DESCRIPTION OF THE DRAWINGS

The summary, as well as the following detailed description, is further understood when read in conjunction with the appended drawing. For the purpose of illustrating the invention, there are shown in the drawing exemplary embodiments of the invention; however, the invention is not limited to the specific methods, compositions, and devices disclosed. In addition, the drawing is not necessarily drawn to scale. In the drawing:

FIGS. 1A-1F depict an exemplary, non-limiting information and process flow for the disclosed methods;

FIG. 2 illustrates an exemplary return summary according to the disclosed methods;

FIG. 3 presents an exemplary table of industry value associated with a given retrofit project;

FIG. 4 presents a graphical depiction of the table shown in FIG. 3, which graphical depiction allows for ready assessment of the revenues associated with the project participants;

FIG. 5 presents an exemplary public cost/benefit summary associated with an exemplary project; and

FIGS. 6(a) and 6(b) present an exemplary input interface.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range. All documents mentioned herein are incorporated herein by reference in their entireties for any and all purposes.

The disclosed methods maybe applied to facilitate energy efficiency investment transactions between commercial building owners, energy efficiency investors, and/or between energy service providers and building owners. The disclosed methods address the foregoing by providing (e.g., via a web-based application or internet connection) financial return projections for commercial retrofits under several financing scenarios. This may be used to create a portfolio of retrofit projects that investors can pre-screen (online, if desired) before contacting a building owner concerning a retrofit project. Alternatively, the disclosed methods may be used by building owners to evaluate options for financing the retrofit or even to identify a set of retrofit measures that will provide a suitable (or even highest) financial return.

The present disclosure presents a number of benefits, including benefits to investors, building owners and society. These benefits include, inter alia, matching project investors with investment-grade projects, reducing investors' transaction costs to find energy efficiency projects, helping building owners to make the internal business case for energy efficiency, expediting the decision process for efficiency investments, and stimulating market transformation of the energy efficiency industry.

Initial data may be input into the model by building owner representatives, which will include information about their buildings, their energy rates, their companies and the type of retrofit measures they plan to install. The financial return projections will benefit the building owners, who often have to rely upon simple payback projections made by manufacturers' representatives or energy service companies. They benefit the investors who will receive a bundled package of projects that meet their investment criteria, dramatically reducing their project acquisition costs. They benefit the energy service provider, who will be able to provide a more comprehensive picture of the project's costs and options for the customer, and reduce the decision time for their customers. Society will benefit from jobs created by a growing industry. Reduced energy consumption leads to less demand for burning coal or natural gas to fire power plants, creating environmental benefits. The disclosure also describes providing benefit return projections from the perspectives of building owners, private investors and public investors.

Data may be input into the model by building owner representatives, who input basic information about their buildings and the type of retrofit measures they plan to install. The resulting financial return projections are especially useful to building owners, who historically have been forced to rely on simple payback projections made by manufacturers' representatives, energy service companies, or other service providers. Commercially-available data on energy consumption, retrofit efficiency, and retrofit costs may also be incorporated into the models, as the models do not necessarily rely only on data input by building owners.

In some embodiments, the disclosed methods (which may be referred to herein as “models” in some instances) provide financial return projections from a variety of investment scenarios. The models may account for eligible rebates, tax incentives, and provide project cost projections as explained further herein. Additional benefit projections for public investors include job creation, energy savings and CO₂ reduction. These projections can be developed for individual buildings as well as for a portfolio of buildings.

As explained herein in further detail, the methods may include user selection of retrofit options. The selection of a retrofit option may effect incorporation into the model of cost and other information associated with that selection. Information associated with a selection may be based upon historical data associated with actual or “live” facilities. As one example, selection of the use of a compact fluorescent lighting system may trigger input of data based on historical building retrofits using a compact fluorescent lighting system. Data may also be provided by one or more service providers with experience in the field, commercially purchased market research on construction costs, and primary market research with both building owners and service providers who have conducted retrofits.

In one embodiment, the present disclosure presents methods, which methods may include improving facility energy management. These methods may, for example, be applied to evaluate the financial return expected from an energy-related investment (such as a retrofit option) in a building, facility, or a portfolio or group thereof. The methods may in some embodiments include generating a predicted energy savings figure (which may, in some non-limiting embodiments, be presented as an energy usage figure) related to the use of one or more retrofit options selected from a set of retrofit options. In other embodiments, information related to the retrofit option may be input by the user. The set of retrofit options may be stored in a memory, such as a database, spreadsheet, hard drive, memory stick, or other computer-readable memory. The retrofit options may also be stored “in the cloud” or on some other non-local storage system.

The term “retrofit option” can refer to adding a new feature (e.g., addition of solar panels, installation of wastewater recycling system, installation of lighting controls, or variable speed drives on an HVAC system) to a facility. “Retrofit option” may also refer to changing an existing feature of a facility, e.g., changing a facility boiler from being coal-fired to being oil-fired, or, e.g., changing a facility's HVAC system to cooling equipment that is Energy Star certified with high energy performance. The term “retrofit option” may also refer to removing a feature from a facility, e.g., removing incandescent lighting from a building.

A retrofit option may be selected from a pre-set list of such options. This pre-set list of options may be present in a memory, such as a database, spreadsheet, hard drive, memory stick, or other non-transitory or transitory computer-readable medium. The list of options may be updated by the user and may also be updated automatically via an internet connection that provides periodic updates.

As one example, a user may select solar panels from a list of building retrofit options. The option selection may include pre-set parameters (e.g., the solar option may have pre-set values for the number of panels, the electricity generated per panel, and the cost per panel), or the user may input parameters associated with the option. In the case of solar panels, for example, the user might input the electricity generated per panel based on the average number of days of sunlight that occur in a locale of interest. It should be understood that any of the foregoing may be effected by a computing device. For example, the user may perform such selection, input, or both from a personal computing device or a mobile computing device (e.g., smartphone, PDA, and the like). As another example, a user may select more efficient heating equipment from a list of building retrofit options. The option selection may include pre-set parameters (e.g., the heating equipment option may have pre-set values for the size of equipment required for the building's square footage, the electricity consumed by the equipment versus the electricity consumed by the equipment being replaced, and the cost of the unit), or the user may input parameters associated with the option. In the case of heating equipment, for example, the user might input the make and model of the equipment being replaced, to allow the processor to generate a more precise energy savings estimate. The user may perform such selection, input, or both from a personal computing device or a mobile computing device (e.g., smartphone, PDA, and the like).

The retrofit option may be selected over an internet connection. Alternatively, the retrofit option may be selected on a stand-alone computing device that does not necessarily require an internet connection to perform the disclosed methods. It should be understood that some or all aspects of the disclosed technology may be performed over an internet connection. It should also be understood that some or all aspects of the disclosed technology may be performed from a so-called local device or system; in other words, an internet connection is not required to carry out the disclosed technologies. In one such example, the local device or system has loaded into its memory one or more data items (e.g., utility cost data) used to perform the disclosed technologies. The data in the local device may be updated via an internet connection or via other means, such as a memory device.

A preset listing of retrofit options may be selected from a drop-down box in a computer application. The application may also be configured so as to permit a user to type in a retrofit option. The user may then input one or more characteristics (e.g., cost, time to installation, and the like) associated with that retrofit option. In this way, a user may input one or more customized retrofit options that are not present in a listing of preset options. A user may perform the disclosed methods by using a combination of preset and user-inputted (e.g., customized) retrofit options.

Retrofit options may include, without limitation: addition of solar panels, conversion of light bulbs and fixtures to more efficient lighting, lighting controls, controls for airflow in HVAC systems, conversion to more efficient HVAC systems, thermal ice storage to store a building's cooling requirement until off-peak periods, valve and pipe insulation, building insulation, heat recovery, conversion of existing window glass to more energy-efficient glass, installation of energy-efficient roofing material, installation of geothermal heating and/or cooling systems, lighting occupancy sensors, daylighting, installation of higher efficiency motors and fans, high efficiency refrigeration equipment, office equipment controllers, HVAC equipment maintenance, and high efficiency water heaters. This list of measures is non-exclusive, as the disclosed methods apply to virtually any retrofit option, whether that option touches on heating, cooling, electricity, water, ventilation, lighting, parking, or any combination thereof. As will be apparent, the disclosed methods contemplate a broad range of retrofit options, as the methods may be applied to virtually any addition, removal, or alteration to a facility that may affect the facility's energy usage in the present or in the future.

The disclosed methods may also include calculating a return or other value (e.g., a difference in cost, an energy usage figure, and the like) associated with the one or more retrofit options that the user selects. The return may be based on an estimated energy savings realized by the selected retrofit options for the facility and the current configuration of the facility. The return may also be based on estimated energy savings realized by comparing two or more sets of retrofit options, so as to allow the user to select a set of retrofit options that is optimal for their needs. For example, a user may select a first set of retrofit options that includes installation of energy-efficient glass and a second set of retrofit options that includes installation of an energy-efficient roof, and then compare the estimated energy usage of the facility under each of these two retrofit options. It should be understood that a user may select a path that includes one retrofit option (e.g., addition of solar panels), two retrofit options (e.g., addition of solar panels and addition of energy-efficient window glass), or more retrofit options. In this way, a user may identify the set of retrofit options that suits their needs while also generating an acceptable return.

The disclosed methods may, for example, also include generating a cash flow figure from various financing options. This cash flow figure may be based on an estimated energy savings realized between one or more selected retrofit options for a facility and the current configuration of that facility. The cash flow figure may include the impact of a financial incentive, such as a rebate or even a tax incentive associated with one or more of the selected retrofit options. Rebates for energy efficiency equipment are available through utilities in numerous states. One non-limiting example is the PECO Energy's Smart Ideas™ program in Pennsylvania. Grants for installing energy efficiency equipment are also available through numerous, including the Pennsylvania Economic Development Association (PEDA)™ program in Pennsylvania, and through the United States Department of Treasury. Tax credits are also available through various state programs, including Kentucky's Energy Efficiency Tax Credit. The disclosed methods may also include calculation of a net present value associated with the selection of one or more retrofit options.

The methods may also include estimating a societal benefit associated from the one or more selected retrofit options. Such benefits may include, for example, job creation, carbon reduction, and reduction in heat island effects. One such job creation benefit might include, for example, the number of jobs (or, alternatively, worker-hours, wages, and the like) that result from the installation and maintenance of a retrofit option (e.g., solar panels) at a facility. A carbon reduction is achieved for each kilowatt hour (kWh) that is reduced through energy efficiency or, e.g., by each kWh that is generated by a renewable energy source such as solar, geothermal or wind energy. This is because alternative generation sources powered by fossil fuels are displaced by reducing kWh needed through energy efficiency or by generating kWh through a non-carbon fuel source such as renewable energy. The amount of carbon displaced depends upon the “electrical emissions coefficient” of each region, which is a factor of the fuel mix of each region's generation portfolio. Presently, carbon reduction can be monetized through carbon auctions in the states of CT, DE, ME, MD, MA, NH, RI, and VT. Other environmental attributes that can be monetized on a national level include NOX and SOX reductions through the EPA cap and trade auctions.

In some embodiments, the disclosed methods include generating the predicted energy savings figure based at least in part on one or more facility characteristics. Some such characteristics include building usage, net occupancy, and the like. These may be selected from a pre-set list of characteristics. Facilities and their characteristics may be stored in a memory (non-transitory or transitory) that is accessed by a user. Example memories may include, e.g., a database, spreadsheet, hard drive, memory stick, or other computer-readable memory. For example, building usage may be quantified in terms of occupancy expressed as person-hours. Usage may also be expressed in terms of the percentage of building area in use. Net occupancy refers to the percentage of assignable space that is in use, e.g., being rented. Energy savings may be offset by an increase in this percentage. This increase in rented space will result in an increase in energy costs, as well as a corresponding increase in rental income. The disclosed methods consider this occupancy in calculating cash flow.

In some embodiments, the predicted energy savings figure is based at least in part on actual energy savings achieved by one or more of the retrofit options. These actual energy savings may be computed from the retrofit option implemented in one or more facilities, such as commercial buildings.

The cost of a retrofit option may be based, for example, on the materials, labor, profit, or other variables associated with the retrofit option. As one example, the cost of retrofit option may be based at least in part on the cost (which may be expressed in $/sq. ft., for example) associated with any building designers, auditors, contractors, and engineers that may participate in the retrofit. These costs may be pre-set such that selection of a particular retrofit option affects the use of pre-set costs associated with that retrofit option. These costs may be based on a database of actual retrofit projects (e.g., based on historical data, such as industry averages) that are loaded into the model and that, in some embodiments, are updated as new data become available. In addition to costs of actual retrofit projects, costs are calibrated with the consumer price index (CPI) for various regions of the country and are automatically updated with fluctuations in the CPI. The methods may also include user-input of costs such that the user may input some or all cost associated with a particular retrofit option.

The methods may be adapted to consider a variety of costs. For example, the methods may include as input costs associated with a general contractor, an electrical contractor, a mechanical contractor, or even a total contractor cost. The methods may also include as inputs costs associated with lighting equipment, HVAC equipment, and construction material. Other costs include total building envelope (e.g., roof top, doors, windows, walls, insulation, and the like), domestic hot water, domestic hot water—plumbing, and the like. Professional services, including architect, engineering, construction manager, lighting design, energy consulting, and auditors may also be model inputs. These inputs may include the number of workers (or worker-hours) associated with effecting the retrofit option; this information may in turn be used to estimate a public or societal benefit from a given retrofit option selection.

A cash flow figure (which figure may be displayed, delivered over an internet connection, or both) may be generated, at least in part, on estimating at least one of a change in facility occupancy and corresponding energy consumption that is related to the one or more selected retrofit options. A cash flow figure may also be generated, at least in part, on a change in facility income associated with the one or more selected retrofit options. Cash flow may be affected by a third party contribution, such as a utility rebate or other public incentive. Such contributions may be expressed in terms of a flat fee or even as a percentage of project cost or some other figure. These public incentives may be pre-set, or may be entered by a user, and may include, for example, a governmental contribution, such as a grant, low interest loan, tax credit or other type of government financial incentive designed to offset the total cost of installing energy efficiency equipment. These incentives are available through utilities, the Federal government, state governments, some banks and non-profit organizations such as the state Clean Energy Funds established through utility restructuring and administered through community development organizations.

Cash flow may also be adjusted based on a change in the predicted energy usage or net occupancy of the facility. A change in the energy usage may relate, for example, to a change in the cost of one or more utilities or other energy source for the facility. A utility may be, for example, natural gas, heating oil, or electricity. The cash flow may also be adjusted based on a predicted maintenance cost (whether positive and negative) for the facility, as well as a predicted occupancy information for the facility. The methods may also use as an input interest rates, which may be in turn applied to estimate borrowing or other financing costs. Any cost may be stored in a non-transitory or transitory computer-readable memory medium, such as a database, spreadsheet, hard drive, memory stick, or other computer-readable memory; memories include “cloud”-based memory that does not necessarily require local memory such as a hard drive. The memory may in turn be accessed by a user during performance of the methods.

The user may also specify a type of facility. Exemplary types of facilities include commercial facilities (e.g., retail facilities, office buildings, warehouses, and the like). Facility information may include facility size; the user may also specify facility location. This may be done by, for example, entering facility information from the users' properties, and correlating each facility type with energy savings data from similar building types stored in the database. In some embodiments, a user may select facility information from facility information (facility type, facility location, facility characteristics) that is stored in a database. This database may suitably include historical information based on comparable facilities. The database may include such information categorized by geography (e.g., city, state, region). In other embodiments, a user may input their own facility information. This information may include, for example, one or more of facility type, square footage, utility usage, facility operations, and the like. In some embodiments, the returns generated by the model are driven by a set of surrogate returns in a database that correspond to information input by the user. Such surrogate returns may, in some embodiments, be based on historical data, including projections based on historical data. Facility information may be stored in a memory, such as a database, spreadsheet, hard drive, memory stick, or other non-transitory computer-readable memory.

Some exemplary types of facility information include the gross area of the building (e.g., in terms of sq. ft.), the assignable/usable area of the building, the building's year of construction, the number of floors in the building, the purpose or use (e.g., office, institutional, health care, industrial, and the like) of the building. The methods suitably include incorporation of information that is associated with one or more of these types of facility information. For example, the year in which the building was built may be associated with a certain level of heat loss that is characteristic of buildings constructed at that time. The building information may also include an occupancy rate, rental costs, and hurdle rate. A hurdle rate is the rate of return established by a corporation that it targets for investment in operations improvements or new growth initiatives.

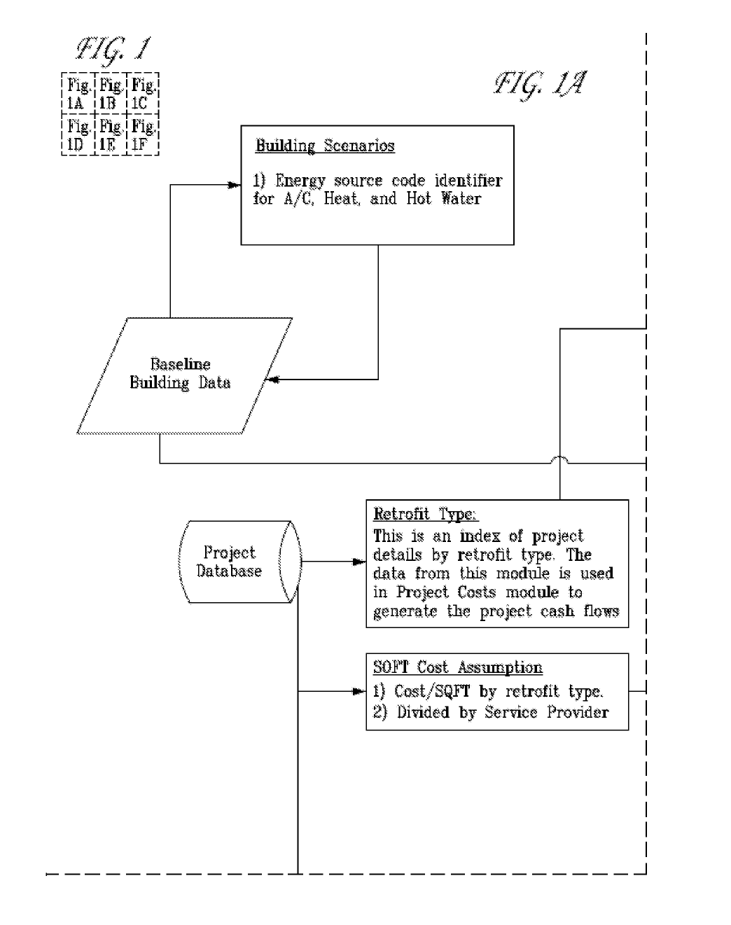

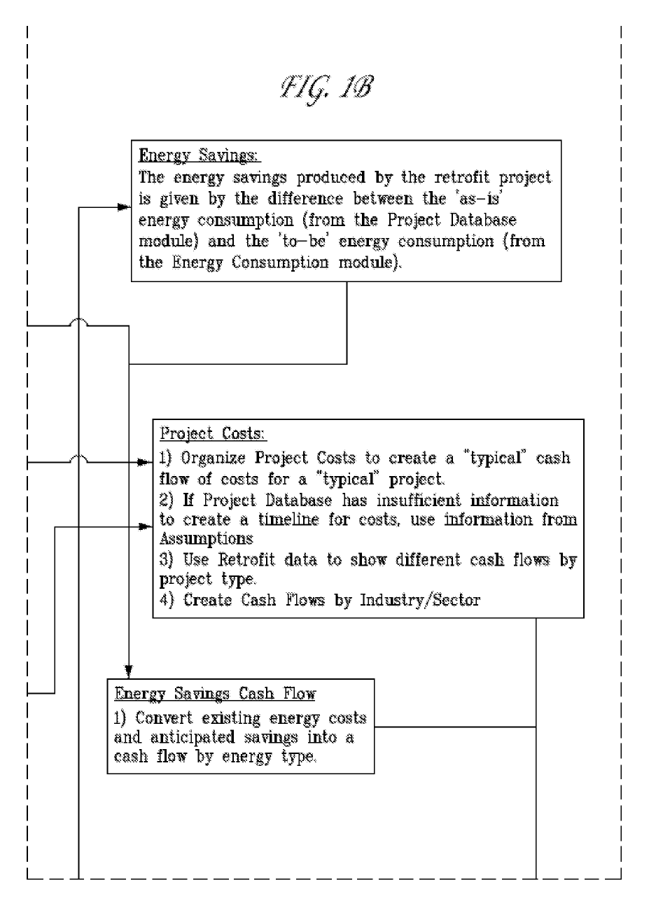

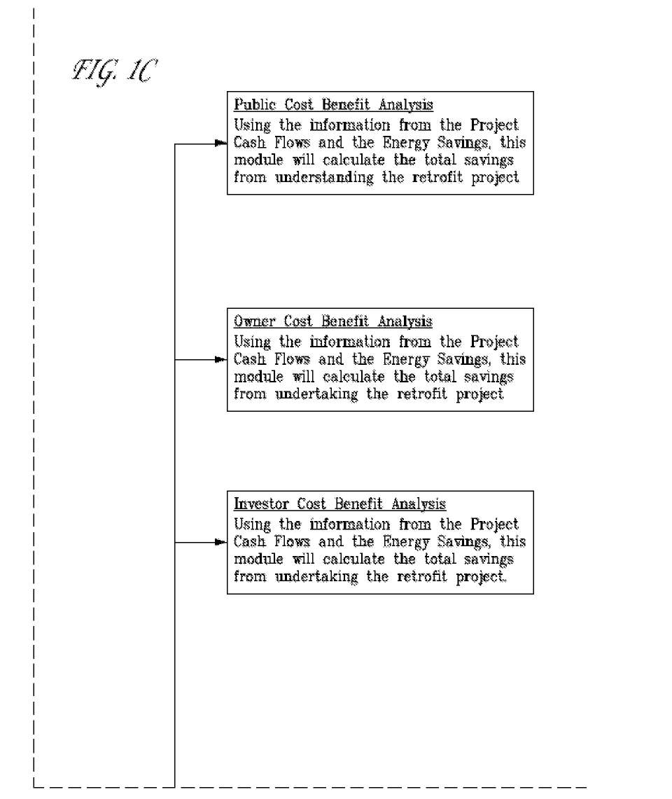

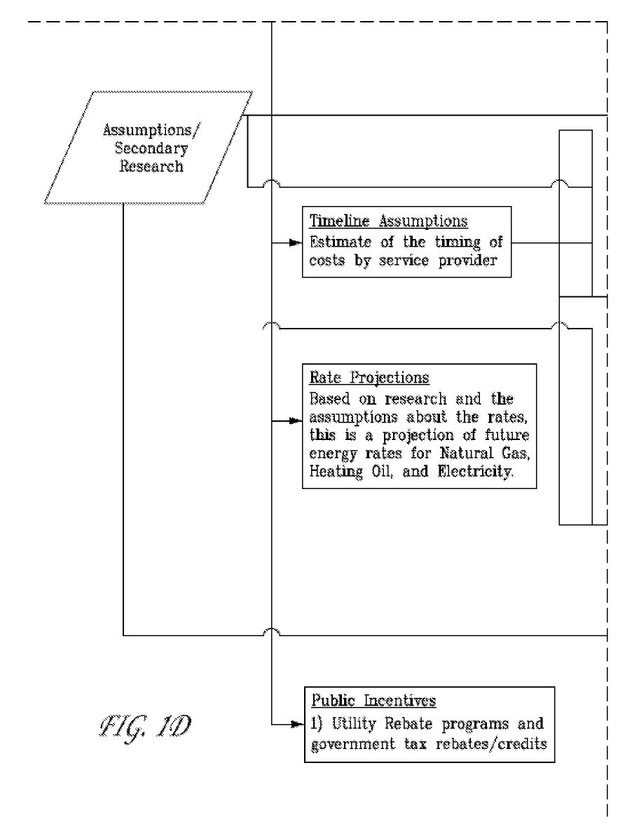

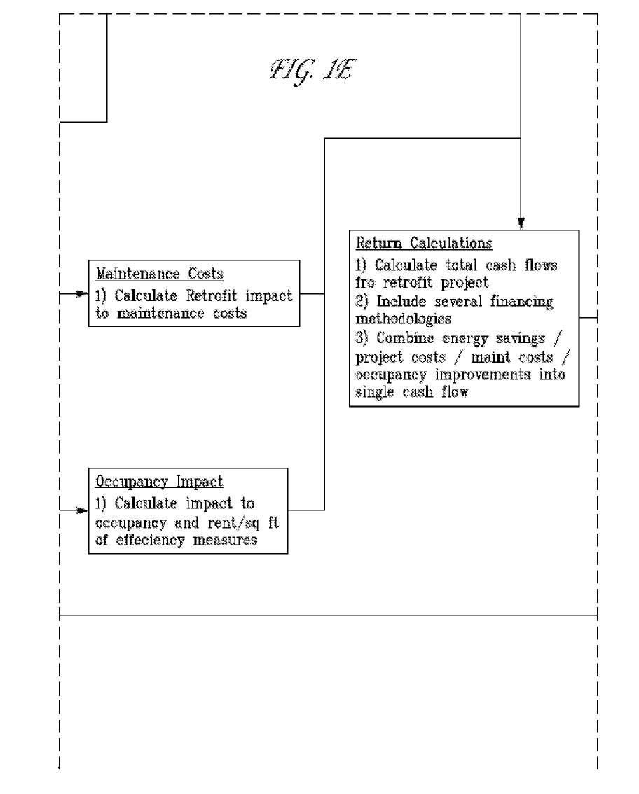

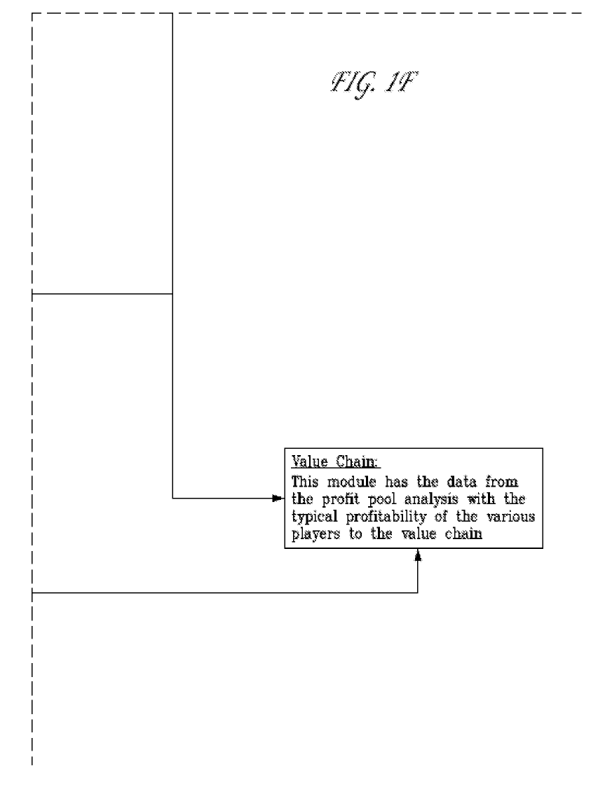

The disclosed methods may, as shown in FIG. 1E, also include calculating returns (e.g., a benefit ratio, a cost ratio, or both) related to the one or more selected retrofit options. The return may be calculated from the perspective of facility owner, a facility investor, a service provider, a community, or any combination thereof. In this way, the methods are capable of displaying a return for one or more prospective parties that may be associated with a retrofit project opportunity, in turn allowing each participant in the opportunity to better understand their own financial return associated with the project. This feature may be termed a “360° return”, and allows for transparency for all involved parties into a retrofit opportunity.

Also provided are systems; in some embodiments, the systems are suitably configured to perform the disclosed methods. The systems suitably include a processor and a memory comprising instructions that, when executed, cause the processor to display on a device one or more fields for user selection, user input, or both, of one or more facility retrofit options from a set of retrofit options, display on a device one or more fields for user selection, user input, or both, of one or more facility configurations and/or locations from a set of facility configurations and/or locations, calculate a difference between a predicted energy usage figure related to user selection, user input, or both of one or more facility retrofit options and a comparative energy usage figure for the facility, and convert the difference to a cash flow, net present value, total cash outlay, and internal rate of return, as well as various other financial indicators. The system may also provide one or more alternative financing options. In some embodiments, the systems include a processor and a memory comprising instructions that, when executed, cause the processor to display on a device one or more fields for user selection, user input, or both, of one or more facility retrofit options from a set of retrofit options, display on a device one or more fields for user selection, user input, or both, of one or more facility configurations from a set of facility configurations, and calculate a predicted energy usage figure related to user selection. It should be understood that the disclosed systems may incorporate one or more functionalities (e.g., input by user, accessing data) that are performed over an internet connection. As one example, a user may use a personal computing device to select and input retrofit selections (e.g., a change to an existing HVAC system) via an internet connection to a processor that in turn executes particular operations based on that retrofit selection.

Facility configurations may include retrofit options. Suitable retrofit options are described elsewhere herein, and may include lighting (e.g., fixtures, controls); heating-ventilation-air-conditioning (HVAC) (e.g., generation, distribution, controls); building envelope options (e.g., windows, doors, insulation, roofing); and plumbing (e.g., domestic hot water).

The memory may, in some embodiments, also include instructions that, when executed, cause the processor to display one or more fields for user selection of one or more facilities from a set of facility types. Facilities are described elsewhere herein, and may include commercial, residential, multi-unit residential and institutional facilities. Office buildings and other commercial properties are considered especially suitable for the disclosed systems and methods.

The memory may also include instructions that, when executed, cause the processor to display one or more fields for user selection (of one or more utility options from a set of utility options. These fields may be drop-down style fields or text-fill-in fields. The memory may also include instructions that, when executed, cause the processor to display one or more fields for user input of one or more facility characteristics.

The memory may further include instructions that, when executed, cause the processor to generate a predicted energy usage figure (a) based at least in part on a user-input utility option, a user selection of one or more utility options from a set of utility options or both, (b) based at least in part on user-input utility rate per unit, user-selected utility rate, or both, (c) based at least in part on user-input facility usage and square footage, by type of utility (or user-selected values for the foregoing), or any combination thereof. The memory may include instructions that, when executed, cause the processor to generate a predicted financial return for a facility owner, a facility investor, a service provider, a community, or any combination thereof. The return may be computed as a return or difference between an existing facility configuration and one or more user-selected retrofit options, utility options, facility type, or even facility location. The memory may also include instructions that display or even compare the expected financial returns for two or more selections of retrofit options, utility, facility type, facility location, and the like.

The system memory may also include instructions that, when executed, cause the processor to effect display of the predicted financial return and a benefit/cost to each individual party to a retrofit project.

The present disclosure also includes computer-readable storage media having stored thereon a computer program for carrying out one or more aspects of the disclosed methods. Such media may comprise a non-transitory computer-readable medium or, in some embodiments, a computer-readable transitory medium, such as a carrier wave. The non-transitory computer-readable medium may include, e.g., a hard drive or RAID array, magnetic tape, an optical storage device (e.g., a CD or DVD), a punch card, a memory stick, RAM, ROM, flash memory, a floppy disk, and the like. Such media may be incorporated into the disclosed systems and may also be used to perform the disclosed methods.

Also provided are methods of energy management, which methods may be used to improve facility energy management. These methods may include, for example, evaluating the financial return of commercial energy efficiency investments in individual buildings or throughout a portfolio of buildings. The methods suitably include receiving, over the internet, user selections of one or more retrofit options selected from a set of retrofit options; generating a predicted energy usage figure related to the use of one or more retrofit options selected from a set of retrofit options; calculating a difference between the predicted energy usage figure and a current baseline energy usage figure for the facility; and generating a cash flow figure and financial return based at least in part on the difference. One or more of the foregoing steps is suitably performed by using a computer processor; for all methods disclosed herein, one or more steps of the method is suitably performed by using a computer processor.

The methods may also include calculating a difference between [1] a predicted energy usage figure based on selection of a first retrofit option or a first set of retrofit options and [2] a predicted energy usage figure based on selection of a second retrofit option or a second set of retrofit options.

The methods may further include communicating the cash flow figure and financial return to a recipient. This communication may be effected by way of an internet connection, as explained elsewhere herein.

A non-limiting embodiment of the disclosed methods is presented in FIGS. 1A-1F. These figures present an exemplary, non-limiting depiction of the disclosed methods' operation. As shown in FIG. 1A, the disclosed methods may include use of baseline building data. Such data may include, for example, information (which may include an energy source code identifier) for air conditioning, heating, and water utilities. These data may be provided by the building owner, but may also be based on historical data concerning these utilities. It should be understood that although shown in the figure, the SQFT Cost Assumption need not necessarily include a step of dividing by service provider.

The methods may also include the use of a project database, as shown on the left-hand side of FIG. 1A. Such a database may include information concerning retrofit type, which information may relate to one or more retrofit options available for the project. Data from this aspect of the methods may be used to generate project cash flows and financial returns. The project database may also include information concerning certain cost assumptions, such as costs associated with retrofit type. Such costs may also be grouped or otherwise divided by types of service providers, e.g., costs associated with engineering services, costs associated with plumbing services, and the like. The project database may also include assumptions or estimates concerning the division and timing of costs by one or more service providers. As one example, the model may include initial cost for demolition services by a construction service provider, followed next by costs associated with removal and replacement of wiring or plumbing. In this way, the methods may accurately consider when certain costs are likely to be incurred during the course of a retrofit project opportunity.

The database may also include, as described above, data concerning utility rates. This may include information related to the usage and/or cost of utilities, the projected cost of utilities, and the like. Exemplary utilities include natural gas (e.g., in CCF/sq. ft.) heating oil (Gal/sq. ft.), and electricity (kWh/sq. ft.). The models may also include, as an input, a growth rate associated with the usage, cost, or both of a utility. The impact of a retrofit option on maintenance costs and also on occupancy and even on rent may also be considered. Impact on rent may be expressed in terms of percentage of the facility that is rented, in terms of rental revenue, or both.

The database may also include data related to public incentives, such as rebates, tax rebates, credits, tax credits, and the like. The database may also include information concerning the project timeline. For example, a particular opportunity may have a completion timeline of 36 months, which time constraint would in turn be contained in the database and would be applied as appropriate during performance of the disclosed methods. Data used in the disclosed technology may be data that is adjustable (based on actual data or on estimates) by geography, building size/type, consumer price index, and the like. It should be understood that data used in the disclosed technology may be static or may be updated or updatable. As one example, the data upon which the disclosed systems operate may be updated by ongoing reference to the Consumer Price Index, inflation, interest rates, or other figures that may change over time. Updating may be accomplished by an internet connection, by local memory device (e.g., memory stick), or by other means known to those of ordinary skill in the art.

FIG. 1D also presents the role of assumptions (and/or secondary research) in the disclosed methods. One such assumption may relate to the savings produced by the retrofit project is given by the difference between the present or “as-is” energy consumption (which may be derived from the Project Database module) and the future or “to-be” energy consumption (from the Energy Consumption module).

As shown in FIG. 1B, the foregoing may be applied to arrive at a set of project costs. This may be effected by organizing project costs to arrive at an expected or even a “typical” cash flow of costs for a given project. When the project database may include insufficient information to create a timeline for costs, the user may also estimate a timeline based on information from the set of assumptions used in the model.

Applying the foregoing, the methods may also generate an energy savings cash flow (FIG. 1B). This may be affected by converting existing energy costs and anticipated savings into a cash flow by energy type. Energy types include, for example, electricity, oil, and natural gas. The energy savings cash flow displays savings by an appropriate unit, such as kilowatts, gallons, and cubic feet. Each of these unit savings is converted to dollars according to an assigned rate schedule. Savings are calculated on a monthly basis from the start of the project and take into account commissioning. Although shown in FIG. 1B, it should be understood that the step of “Project Costs” need not necessarily include the step of creating cash flows by industry/sector.

Cash flow may then in turn be applied to a return calculation. For example, this may be effect by calculating total cash flows for retrofit project. This may include several financing methodologies. For example, a building owner may self-finance an energy efficiency project, or take a loan from a bank or contract with a third-party energy service company that shares in the energy savings with the building owner. In addition, the owner may receive rebates, tax credits, low-interest loans or other type of financial incentives that are factored into the project. The methods may then combine energy savings, project costs, maintenance costs, and occupancy improvements into a single cash flow figure.

The disclosed models may also provide various benefit analyses. The models may provide a public cost benefit analysis. Such an analysis may be performed using information from the Project Cash Flows and the Energy Savings, so as to calculate the public's total savings or return from undertaking the retrofit project, as shown in FIG. 1C. Although shown in FIG. 1C, the methods need not necessarily include the step of public cost/benefit analysis.

The model may also provide an owner cost benefit analysis. Using the information from the Project Cash Flows and the Energy Savings, this module may calculate the owner's total savings (or return) from undertaking the retrofit project. The methods may also calculate the cost benefit to an investor, by using information from the Project Cash Flows and the Energy Savings to calculate the total savings or return from undertaking the retrofit project.

The model may also provide a value chain benefit analysis, as shown in FIG. 1F. This module addresses data from the project profit pool with an expected typical profitability for the various project participants. The profit pool is the projected profitability of each service provider involved in the retrofit project. These projections were derived through secondary and primary market research. This research included purchasing profit margin research for participating types of service providers and validating that research with participants from an Energy Efficient Bulding Hub (EEB Hub, www.eebhub.org) group involved in the service industries, as well as conducting market research with building owners, investors and service providers. Data (e.g., cost estimates, historical costs, and the like) may be collected from various sources known to those in the art, including utility companies, facility managers, and the like. Although shown in FIG. 1F, the disclosed methods need not necessarily include a value chain module.

The disclosed methods may also be used to provide an aggregate or total return figure for a given selection of retrofit options. This total return figure may include worker-hours created, profit to investors, reduction in carbon in other emissions, and energy or utility savings. In this way, the methods enable the user to obtain a comprehensive picture of all returns associated with a given retrofit option selection. The total return figure or summary may be used in selecting between retrofit option project opportunities, as an opportunity may afford comparatively high financial returns to investors without also affording similarly high societal benefits in terms of job creation or emissions reduction. Such an opportunity may be less attractive to certain investors (e.g., a publicly-funded investor) that place a higher premium on job creation. In this way, the disclosed systems and methods allow project participants to obtain a comprehensive view of the different benefits and returns associated with their facility retrofit options.

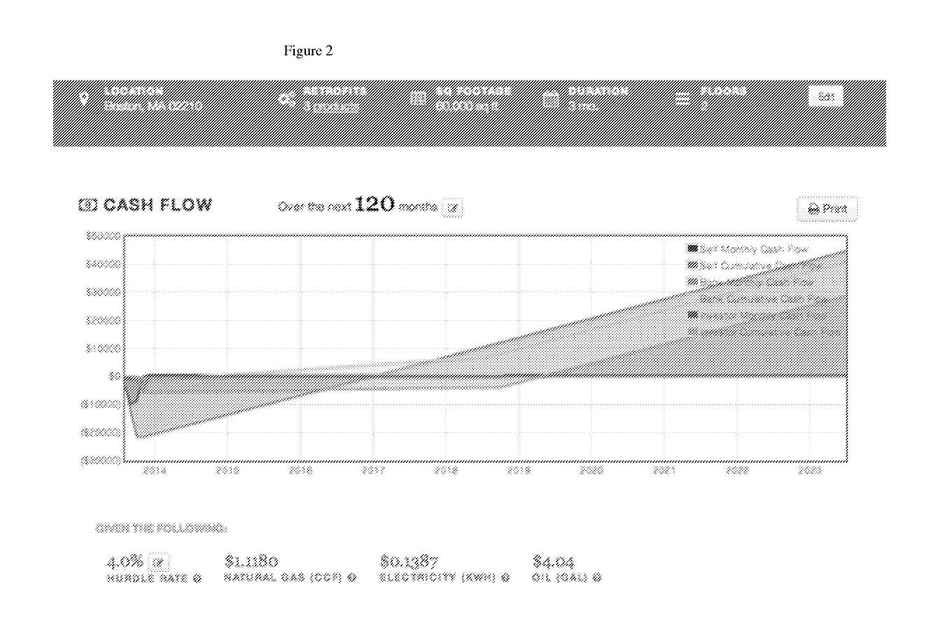

FIG. 2 presents an exemplary return analysis for an owner-financed retrofit option. As shown in the figure, the methods may be configured to output a hurdle rate (4% in the figure), the NPV of costs at that hurdle rate, the NPV of savings at that hurdle rate, and the NPV of the profit increase at that hurdle rate. The methods may also provide a total cash flow NPV, as well as internal rate of return, a cash on cash multiple, a maximum cash out, and the payback period for the retrofit opportunity. The model may also provide a benefit/cost ratio for the project.

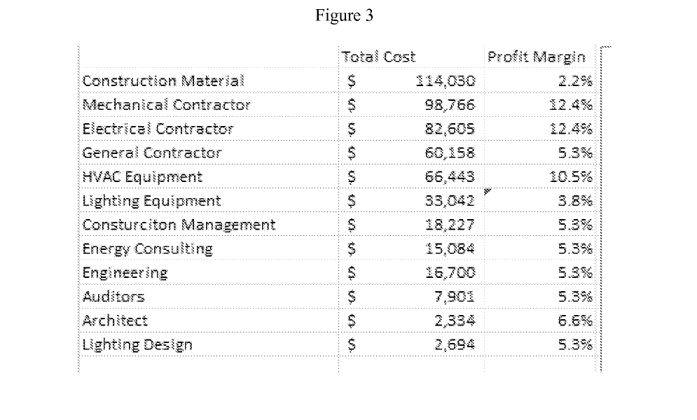

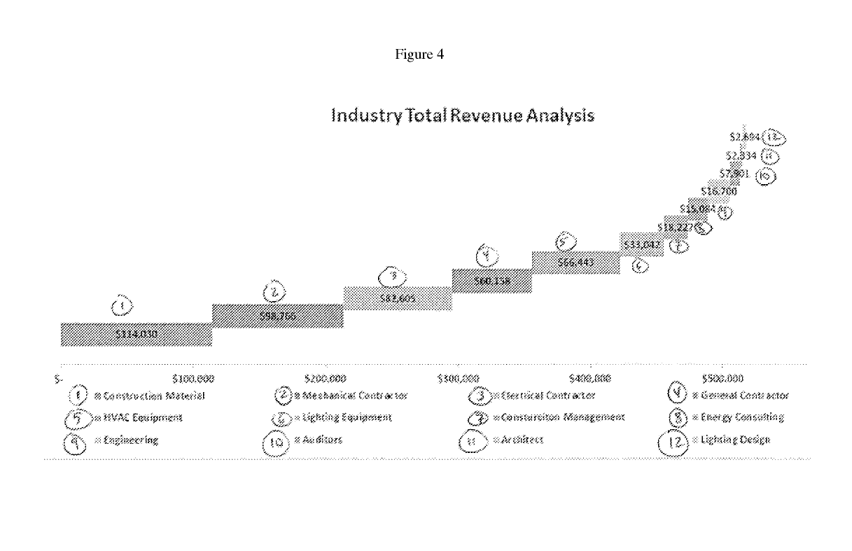

FIG. 3 presents an exemplary table of industry value associated with a given retrofit project. As shown, the methods allow for summary of the total cost and profit margins for the various participants in a given retrofit project. FIG. 4 presents a graphical depiction of the table shown in FIG. 3, which graphical depiction allows for ready assessment of the revenues associated with the project participants.

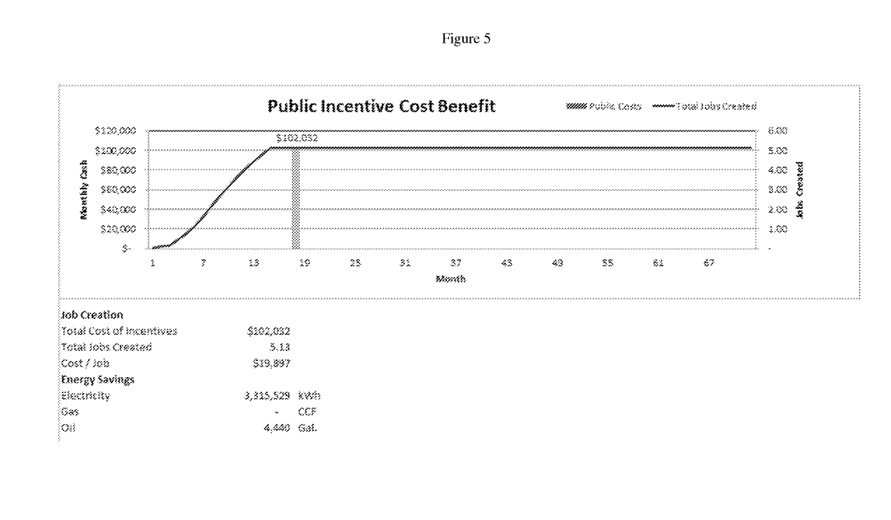

FIG. 5 presents, from the public perspective, a cost/benefit analysis for a project. As shown, the disclosed methods may illustrate the costs (e.g., in the form of public incentives such as rebates that are provided to the project), energy savings, and job creation associated with a given project. In this way, one may visualize the job creation benefits and energy savings of a project as they relate to the public cost of that project.

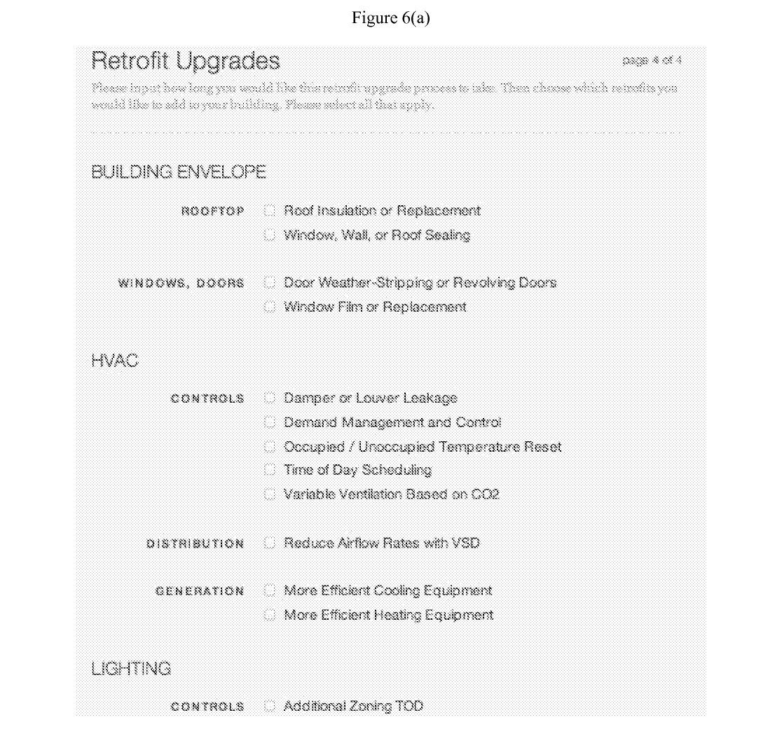

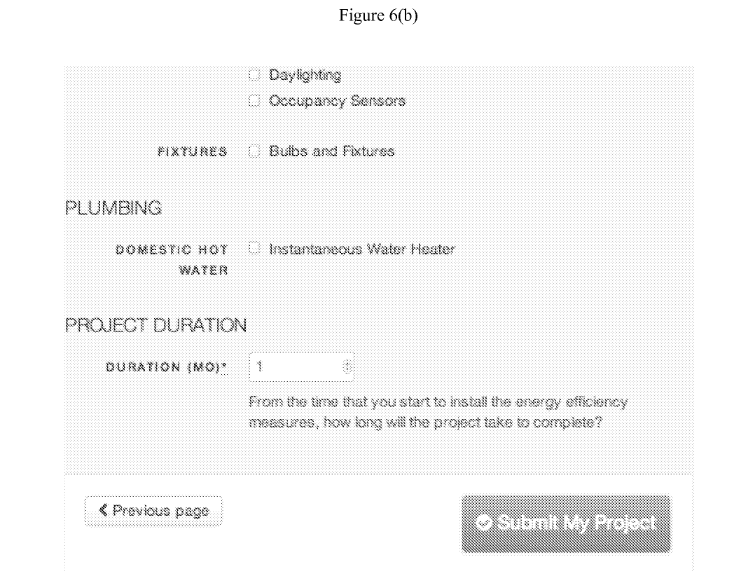

FIGS. 6(a) and 6(b) provide an exemplary, non-limiting input interface for analyzing retrofit upgrades. As shown in FIG. 6(a), a user may elect to upgrade roofing, windows, and/or doors. A user may also upgrade HVAC systems and lighting (continued on FIG. 6(b)), as well as plumbing. A user may also input an estimated duration to the project, as shown in FIG. 6(b).

What is claimed:

1. A method of improved facility energy management, comprising:
(a) generating a predicted energy usage figure related to the use of one or more retrofit options selected from a set of retrofit options;
(b) calculating a difference between the predicted energy usage figure and a comparative energy usage figure for the facility; and
(c) generating a cash flow figure based at least in part on the difference, wherein at least one of (a), (b), and (c) is effected by using a computer processor.

2. The method of claim 1, further comprising generating the predicted energy usage figure based at least in part on one or more facility configurations selected from a set of facility configurations stored in a memory.

3. The method of claim 1, further comprising generating the predicted energy usage figure based at least in part on one or more utility options selected from a set of utility options stored in a memory.

4. The method of claim 1, further comprising generating the predicted energy usage figure based at least in part on a maintenance cost related to the one or more selected retrofit options stored in a memory.

5. The method of claim 1, further comprising generating the cash flow figure based at least in part on estimating at least one of a change in facility occupancy related to the one or more selected retrofit options or a change in facility income related to the one or more selected retrofit options.

6. The method of claim 1, further comprising calculating a change in the cash flow figure effected by a third-party contribution.

7. The method of claim 1, further comprising calculating a change in the cash flow figure effected by a change in the predicted energy usage.

8. The method of claim 1, further comprising selecting at least one of the facility type and the facility location, from a set of facility types and facility locations.

9. The method of claim 1, wherein the one or more retrofit options are selected over an internet connection.

10. The method of claim 1, wherein at least one of (a), (b), or (c) is effected by a computing device.

11. The method of claim 1, further comprising calculating a return related to the one or more selected retrofit options for a facility owner, a facility investor, a service provider, a community, or any combination thereof.

12. A system for improved energy efficiency management, comprising:
a processor; and
a memory comprising instructions that, when executed, cause the processor to
display on a device one or more fields for user selection, user input, or both, of one or more facility retrofit options from a set of retrofit options,
display on a device one or more fields for user selection, user input, or both, of one or more facility configurations from a set of facility configurations,
calculate a difference between a predicted energy usage figure related to user selection of one or more facility retrofit options and a comparative energy usage figure for the facility, and
convert the difference to a cash flow, a return on investment or any combination thereof.

13. The system of claim 12, wherein the memory further comprises instructions that, when executed, cause the processor to (a) display one or more fields for user selection, user input, or both of one or more facilities from a set of facilities, (b) display one or more fields for user selection, user input, or both of one or more utility options from a set of utility options, or (a) and (b).

14. The system of claim 12, wherein the memory further comprises instructions that, when executed, cause the processor to generate the predicted energy usage figure (a) based at least in part on user input, user selection of one or more utility options from a set of utility options, or both, (b) based at least in part on user input, user selection or more maintenance options from a set of facility maintenance costs, or both.

15. The system of claim 12, wherein the memory further comprises instructions that, when executed, cause the processor to generate a predicted financial return for a facility owner, a facility investor, a service provider, a community, or any combination thereof.

16. A method of improved facility energy management, comprising:
receiving, over the internet, user input of one or more retrofit options, user-performed selections of one or more retrofit options selected from a set of retrofit options, or both;
generating, using a computing device, a predicted energy usage figure related to the use of one or more user-input retrofit options, user-selected retrofit options, or both;
calculating a difference between the predicted energy usage figure and a comparable energy usage figure for the facility; and
generating a cash flow figure and financial return based at least in part on the difference.

17. The method of claim 16, wherein the receiving is performed over an internet connection.

18. The method of claim 16, further comprising communicating the cash flow figure to a recipient.

19. A method of improved facility energy management, comprising:
(a) generating a predicted energy usage figure related to the use of one or more retrofit options selected from a set of retrofit options;
(b) calculating a difference between the predicted energy usage figure and a comparative energy usage figure for the facility; and
(c) generating a return figure based at least in part on the difference.

20. The method of claim 19, wherein the return figure comprises a return on investment, a cost/benefit analysis, an alternative financing option, or any combination thereof.
